(19) United States
(12) Patent Application Publication
(10) Pub. No.: US 2002/0119710 A1
(43) Pub. Date: Aug. 29, 2002

(54) Electrical connector having frame and slidable members

(75) Inventors: Keith F. Mello, Manchester, NH (US); Gary E. Schrader, Manchester, NH (US); Daniel D. Dobrinski, Raymond, NH (US)

Correspondence Address: PERMAN & GREEN, 425 POST ROAD, FAIRFIELD, CT, 06430, US

(73) Assignee: FCI USA, Inc.

(21) Appl. No.: 09/794,610

(22) Filed: Feb. 27, 2001

(51) Int. Cl. H01R 4/50

(52) U.S. Cl. 439/783

(57) ABSTRACT

An electrical connector comprising a frame; and a first set of clamping sliders comprising a first claming clamping slider movably connected to the frame, and a second clamping slider movably connected to the frame. The first and second sliders are located opposite each other with a first conductor receiving area therebetween. The first and second sliders have slide paths along the frame which are angled relative to each other. The slide path of the second slider is substantially parallel to a center longitudinal axis of the conductor receiving area.

### BACKGROUND OF THE INVENTION

1. Field of the Invention

The present invention relates to electrical connectors and, more particularly, to a connector for attaching to an end of a conductor.

2. Prior Art

This invention relates to Mechanical Overhead Splice/Reducer/Deadend connectors used for connecting overhead power distribution conductors by various electric utilities and municipalities. U.S. Pat. No. 3,384,704 discloses a connector for cables. The connector has slidable jaws for automatically gripping the cables. One of the modes of failure with current “automatic” connectors is mechanical failure due to improper installation. Due to the blind nature of the installation process, the installer does not always know if the conductor is fully inserted since there is no positive way to determine if full insertion has been achieved. As a consequence, when full insertion is not achieved, the conductor does not engage with the full length of the jaws inside the connector. This sometimes causes catastrophic mechanical failure. There is a desire to provide an automatic connector in which an installer can determine if full insertion has been achieved.

### SUMMARY OF THE INVENTION

In accordance with one embodiment of the present invention, an electrical connector is provided comprising a frame; and a first set of clamping sliders comprising a first claming clamping slider movably connected to the frame, and a second clamping slider movably connected to the frame. The first and second sliders are located opposite each other with a first conductor receiving area therebetween. The first and second sliders have slide paths along the frame, which are angled relative to each other. The slide path of the second slider is substantially parallel to a center longitudinal axis of the conductor receiving area.

In accordance with another embodiment of the present invention, an electrical connector is provided comprising a frame having a general cross-sectional “U” shape; and two wedges movably mounted to the frame. Each wedge has a conductor contacting surface facing a same direction towards a curved section of the general “U” shape of the frame. Each wedge has a slide path along the frame towards a respective different end of the frame. The respective slide paths towards the ends are angled to move the wedges towards the curved section as the wedges approach their respective ends.

In accordance with another embodiment of the present invention, an electrical connector is provided comprising a frame having a general cross-sectional “U” shape and guide grooves on inward sides of legs of the general “U” shape; and a wedge movably mounted to the frame. The wedge comprises two opposite sides having projections extending into the guide grooves and a conductor contact surface on a side which connects the two opposite sides. The projections each have a longitudinal axis which is angled relative to a longitudinal axis of the conductor contact surface.

In accordance with one method of the present invention, a method of manufacturing an electrical conductor comprising steps of extruding a connector body having an elongate shape with an elongate conductor receiving area inside the body along the elongate shape; and slidably mounting a wedge in the receiving area to opposite sides of the frame such that the wedge can slide along the elongate conductor receiving area. The wedge and body comprise a mating slidable groove and projection which guides a slide path of the wedge along the body.

### BRIEF DESCRIPTION OF THE DRAWINGS

The foregoing aspects and other features of the present invention are explained in the following description, taken in connection with the accompanying drawings, wherein:

FIG. 1 is a perspective view of a connector incorporating features of the present invention with two conductors;

FIG. 2 is a cross-sectional view of the connector shown in FIG. 1 with a conductor in one of the wedges;

FIG. 3 is a cross-sectional view of the connector shown in FIG. 2 taken along line 3-3;

FIG. 4 is a perspective view of an alternate embodiment of a connector incorporating features of the present invention with two conductors;

FIG. 5 is a cross-sectional view of the connector shown in FIG. 4 with a conductor in one of the wedges;

FIG. 6 is a cross-sectional view of the connector shown in FIG. 5 taken along line 6-6;

FIG. 7 is a perspective view of an alternate embodiment of a connector incorporating features of the present invention with two conductors;

FIG. 8 is a cross-sectional view of the connector shown in FIG. 7;

FIG. 9 is a cross-sectional view of the connector shown in FIG. 8 taken along line 9-9;

FIG. 10 is a perspective view of an alternate embodiment of a connector incorporating features of the present invention;

FIG. 10A is a perspective view of an alternate embodiment of the connector shown in FIG. 10 incorporating features of the present invention;

FIG. 11 is a cross-sectional view of the connector shown in FIG. 10 with a conductor in one of the wedges;

FIG. 12 is a cross-sectional view of the connector shown in FIG. 11 taken along line 12-12;

FIG. 13 is a cross-sectional view of another embodiment of the present invention.

### DETAILED DESCRIPTION OF THE PREFERRED EMBODIMENT

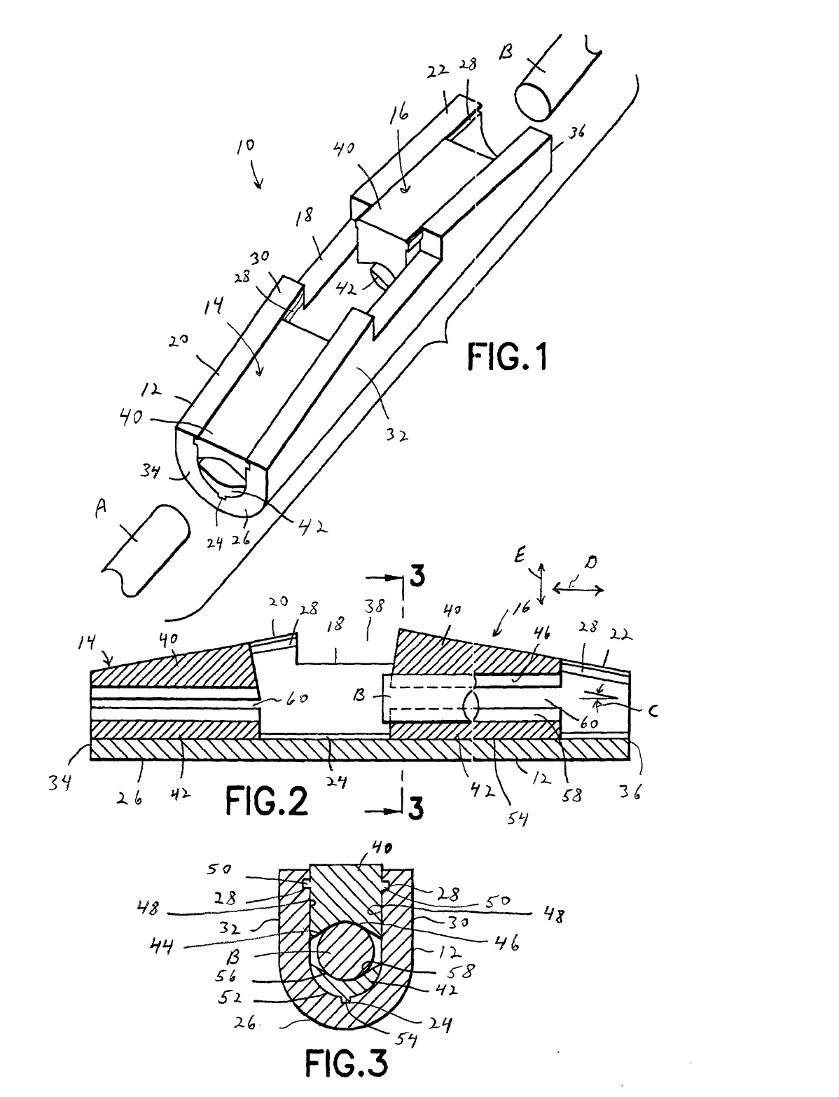

Referring to FIG. 1, there is shown a perspective view of an electrical connector 10 incorporating features of the present invention shown with ends of two connectors A, B intended to be connected by the connector. Although the present invention will be described with reference to the embodiments shown in the drawings, it should be understood that the present invention can be embodied in many alternate forms of embodiments. In addition, any suitable size, shape or type of elements or materials could be used.

Referring also to FIGS. 2 and 3, the connector 10 generally comprises a frame 12 and two sets 14, 16 of sliders movably mounted to the frame 12. The frame 12 is preferably comprised of a one-piece metal member. However, in alternate embodiments the frame could be comprised of more than one member and could be comprised to any suitable material(s). The frame 12, in this embodiment, has a general cross-sectional “U” shape. However, in alternate embodiments the frame could have alternative shapes. In a preferred method of manufacturing the frame, the frame is comprised of a member which has been extruded. However, any suitable manufacturing process(es) could be used. In this embodiment the frame 12 has a center section 18 and two end sections 20, 22 on opposite ends of the center section 18. The inside surface of the frame 12 has a guide groove 24 along a curved section 26 and guide grooves 28 along the two opposite leg sections 30, 32. The guide groove 28 in the two end sections 20, 22 are angled relative to the guide groove 24 towards the ends 34, 36 of the frame 12. The guide grooves 28 in the first end section 20 are angled relative to the guide grooves 28 in the second end section 22 and a cut-out area 38 is provided in the center section 18 such that the guide grooves 28 open into the cut-out area 38.

The two sets 14, 16 of sliders are substantially identical; merely orientated reverse to each other and located in respective end sections 20, 22. Each set comprises a first slider or wedge 40 and a second slider 42. In alternate embodiments the two sets 14, 16 could be different, each set could be comprised of more or less than two sliders, and/or the sliders could have any suitable shape(s). In this embodiment the wedges 40 each have a general wedge shape with an inner side 44 having a conductor contact surface 41 and two lateral sides 48 having projections 50. The projections 50 are slidably located in the upper guide grooves 28. The projections 50 are angled relative to the longitudinal axis of the conductor contact surface 46. In a preferred embodiment the angle of the projections 50 relative to the surface 46 is about the same as the angle C of the groove 28 to the longitudinal axis of the frame. However, in alternate embodiments the angles could be different. With the wedge 40 attached to its respective guide groove 28 the surface 46 is preferably parallel to the longitudinal axis of the frame and the conductor contact surface of the opposite slider 42. In alternate embodiments any suitable movably connection of the wedges to the frame could be provided.

The second sliders 42 each comprise a bottom side 52 having a projection 54 and a top side 56 forming a conductor contact surface 58. In this embodiment the bottom side 52 is slidably located against the inside surface of the curved section 26 of the frame 12. The projections 54 extend into the bottom guide groove 24. However, in alternate embodiments any suitable movable connection of the second sliders 42 to the frame 12 could be provided. In this embodiment the slide paths of the second sliders 42 are along the same axis; parallel to the longitudinal axis of the frame. However, in alternate embodiments any suitable relative positioning of the second sliders to each other and the frame could be provided. The conductor contact surface 58 for each second slider 42 faces the conductor contact surface 46 of its respectively associated first slider 40 in each set 14, 16. In this embodiment the surfaces 46, 58 of each set 14, 16 are parallel to each other regardless of the positions of the sliders 40, 42 on the frame. However, in alternate embodiments they might not always be parallel to each other.

The opposing surfaces 46, 58 for each set 14, 16 form a conductor receiving area 60 therebetween. Thus, two conductor receiving areas 60 are provided; one at each end section 20, 22 of the frame 12. Because the top and bottom grooves 24, 28 in each end section are angled relative to each other, the sliders 40, 42 can move relative to each other as indicated by arrow E when the sliders 40, 42 are moved relative to the frame 12 as indicated by arrow D. Thus, the receiving areas 60 have variable sizes. When the first sliders 40 are located closer towards the center section 18, the areas 60 are larger than when the first sliders are located closer towards their respective associated ends 34, 36. The frame 12 and sets 14, 16 are arranged such that the sliders 40, 42 can be slid back to the center section 18; perhaps to alternate overlapping positions. This allows easier positioning of the conductors A, B in the receiving areas 60 by making the receiving areas 60 larger, but without increasing the length of the frame. Once a conductor is located in one of the receiving areas 60, the sliders 40, 42 for that conductor can be moved towards their respective end 34, 36 to clamp the conductor between the two opposed conductor contact surfaces 46, 58 for that conductor. The conductor can then be pulled outward to further wedge the first slider 40 downward and fixedly clamp conductor to the connector. In an alternate embodiment the second sliders 42 might not be provided, and/or one or more of the sliders might be biased by a spring(s).

“Automatic” splice/dead-end/reducer connectors make up the largest portion of the Power Utility connector market. This invention is an alternative “automatic” style connector that solves some of the design and installation problems inherent with current automatic designs.

One of the current modes of failures with current “automatics” is mechanical failure due to improper installation. Due to the blind nature of the installation process, the installer does not always know if the conductor is fully inserted since there is no positive way to determine if full insertion has been achieved. As a consequence, when full insertion is not achieved the conductor does not engage with the full length of the jaws inside the connector. This sometimes causes catastrophic mechanical failure.

This invention is essentially comprised of an aluminium extruded U-shaped body and two metallic wedges. The bottom wedge slides parallel to the bottom surface of the U-shapes body. The upper wedge moves along an angle such that, when the wedge is moved forward towards the opening of the portion of the body that receives the conductor, the distance between the upper and lower wedge decreases. Thus, a closing or gripping action is achieved. The upper wedge can be retracted backwards to allow the conductor to be partially laid into the U-shaped body, on top of the bottom wedge. In this manner the installer can visually determine that the conductor has been fully inserted into the connector. Once laid, the upper wedge can be moved forward over the conductor and when the conductor is pulled during normal installation process the wedges tighten around the conductor attaching it securely in the connector.

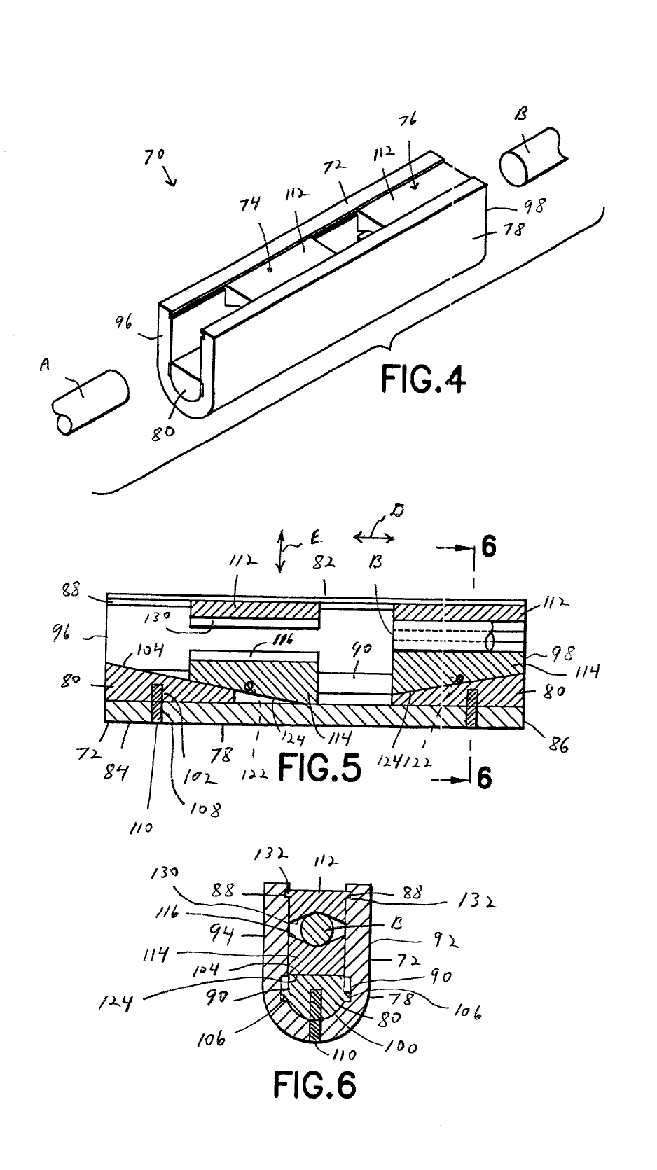

Referring now to FIGS. 4-6 an alternate embodiment of the present invention is shown. In this embodiment the connector 70 generally comprises a frame 72 and two sets 74, 76 of sliders. The frame 72 generally comprises a base 78 and two inserts 80. The base 78 generally comprises a one-piece metal member. However, in alternate embodiments the base could be comprised of more than one member and could be comprised of any suitable material(s). The Base 78, in this embodiment, has a general cross-sectional “U” shape. However, in alternate embodiments the base could have alternative shapes. In a preferred method of manufacturing the base, the base is comprised of a member which has been extruded. However, any suitable manufacturing process(es) could be used. In this embodiment the base 78 has a center section 82 and two end sections 84, 86 on opposite ends of the center section 82. The inside surface of the base 78 has upper and lower guide grooves 88, 90 along the two opposite leg sections 92, 94. The guide grooves 88 are parallel relative to the guide grooves 90. The inserts 80 are also preferrably comprised of metal. The inserts 80 have a general wedge shape with small ends facing each other and larger ends facing the opposite ends 96, 98 of the base 78. The inserts 80 have a curved bottom side 100, fastener holes 102, a sloped top side 104, and lateral projections 106. The curved bottom side 100 is located against the interior surface of the curved section of the base 78. Fasteners 110, such as press-fit pins for example, extend through holes 108 in the base 78 and into the holes 102. The lateral projections 106 extend into the lower guide grooves 90. The inserts 80 are stationarily held to the base 78. However, in alternate embodiments the inserts could have any suitable shape(s) and any suitable means could be used to attach the inserts to the base. The two sets 74, 76 of sliders are substantially identical; merely orientated reverse to each other and located in respective end sections 84, 86. Each set comprises a first slider 112 and a second slider or wedge 114. In alternate embodiments the two sets 74, 76 could be different, each set could be comprised of more or less than two sliders, and/or the sliders could have any suitable shape(s). In this embodiment the wedges 114 each have a general wedge shape with a side 116 forming a conductor contact surface, two lateral sides having projections 122 and a side 124 located against the sloped top side 104 of one of the inserts 80. The projections 112 are slidably located in the lower guide grooves 90. With the wedge 114 attached to its respective guide groove 90, the surface 116 is preferably parallel to the longitudinal axis of the base and the conductor contact surface of the opposite slider 112. In alternate embodiments any suitable movably connection of the wedges to the frame could be provided.

The first sliders 112 each comprise a bottom side 130 forming a conductor contact surface and projections 132 on two lateral sides. The projections 132 are slidably located in the upper guide grooves 88. However, in alternate embodiments any suitable movable connection of the first sliders 112 to the frame 72 could be provided. In this embodiment the slide paths of the first sliders 112 are along the same axis; parallel to the longitudinal axis of the frame. However, in alternate embodiments any suitable relative positioning of the first sliders to each other and the frame could be provided. The conductor contact surfaces 130 for each first slider 112 faces the conductor contact surface 116 of its respectively associated second slider 114 in each set 74, 76. In this embodiment the surfaces 116, 130 of each set 74, 76 are parallel to each other regardless of the positions of the sliders 112, 114 on the frame. However, in alternate embodiments they might not always be parallel to each other.

The opposing surfaces 116, 130 for each set 74, 76 form a conductor receiving area therebetween. Thus, two conductor receiving areas are provided; one at each end section 84, 86 of the base 78. Because the projections 122 of the wedges 114 are movably located in the lower guide grooves 90, and the sloped surfaces 104 and 124 are located against each other, the pairs of sliders 112, 114 can move relative to each other as indicated by arrow E when the sliders are moved relative to the frame as indicated by arrow D. Thus, the receiving areas have variable sizes. When the second sliders 116 are located closer towards the center section 82, the receiving areas are larger than when the second sliders are located closer towards their respective associated ends 96, 98.

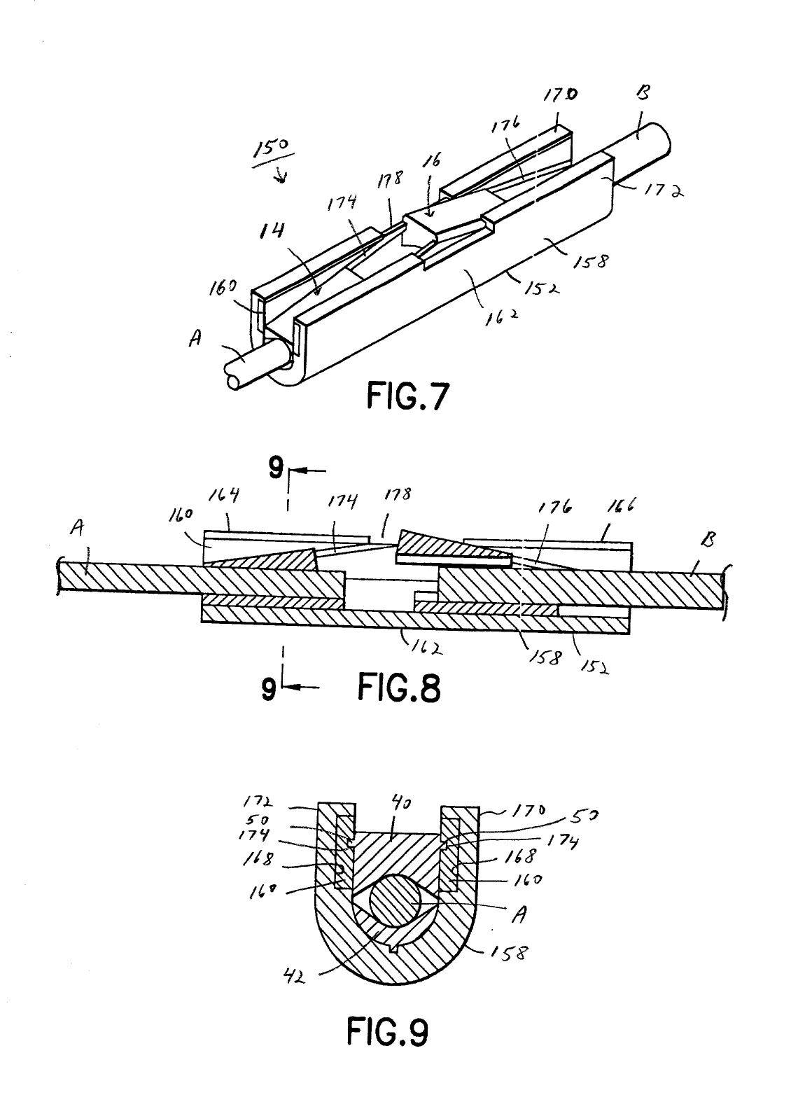

Referring now to FIGS. 7-9 another alternate embodiment is shown. In this embodiment the connector 150 generally comprises a frame 152 and two sets 14, 16 of sliders. The frame 152 generally comprises a base 158 and two inserts 160. The base 158 generally comprises a one-piece metal member. However, in alternate embodiments the base could be comprised of more than one member and could be comprised of any suitable material(s). The base 158, in this embodiment, has a general cross-sectional “U” shape. However, in alternate embodiments other shapes could be provided. In a preferred method of manufacturing the base, the base is comprised of a member which has been extruded. However, any suitable manufacturing process(es) could be used. In this embodiment the base 158 has a center section 162 and two end sections 164, 166 on opposite ends of the center section 162. The inside surface of the base 158 has grooves 168 along the two opposite leg sections 170, 172. The inserts 160 are each located in one of the grooves 168 on respective ones of the leg sections 170 and 172. The inserts 160 are stationarily connected to the base 158. Each insert 160 has two slider guide grooves 174, 176. The grooves 174, 176 are angled relative to each other and extend downward in opposite directions from the middle of the inserts. The grooves 174, 176 open to the top side of the inserts at a cut-out region 178 of the base 158.

The sets 14, 16 of sliders comprise the sliders 40, 42 as described in FIGS. 1-3. The projections 50 of the first sliders or wedges 40 are located in the opposing grooves 174, 176 of the two inserts 160.

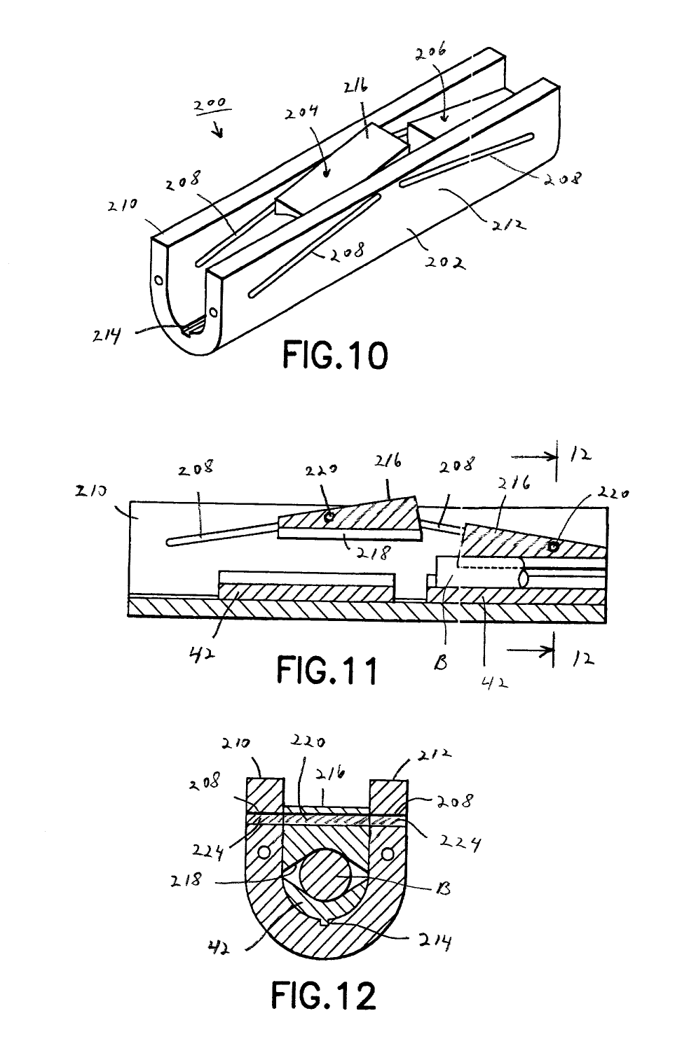

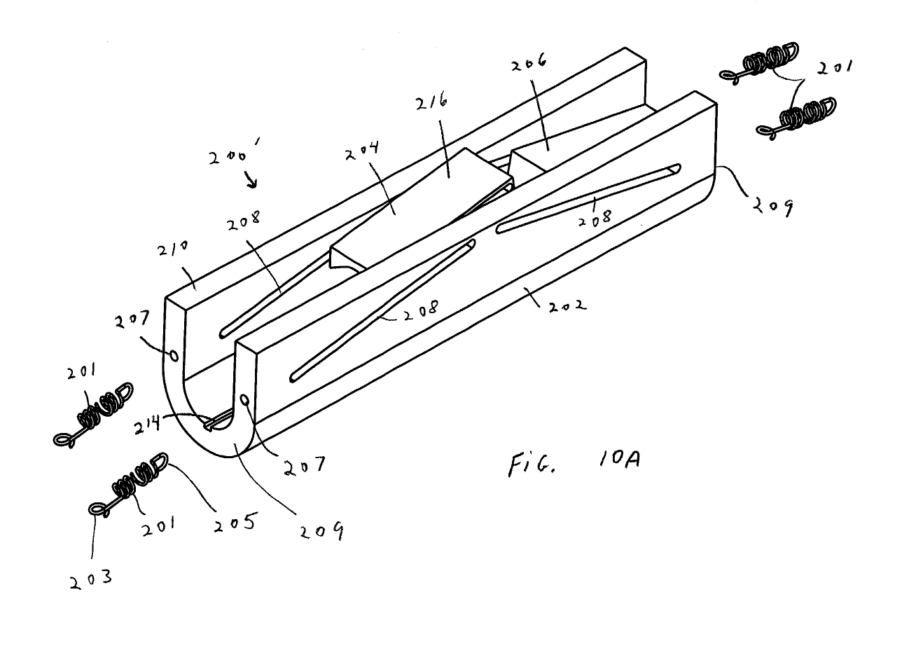

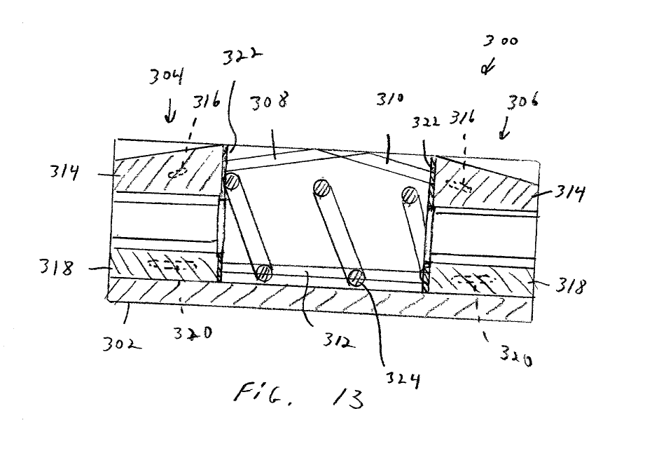

Referring now to FIGS. 10-12, another alternative embodiment is shown. In this embodiment the connector 200 generally comprises a frame 202 and two sets 204, 206 of sliders. The frame 202 has angled pairs of through-holes or slots 208 through its opposite legs 210, 212 and a bottom guide groove 214. The sets 204, 206 of sliders each comprises a first slider or wedge 216 and an opposite second slider 42. The first slider 216 has a bottom conductor contact surface 218 and a mounting pin 220 extents from opposite lateral sides of the first slider 216 and extend into opposing slots 208. The ends 224 are adapted to slide along the slots 208. Because of the slant of the slots 208, the first slider 216 moves in a direction towards its opposite second slider 42 as the first slider is moved towards its associated end of the frame. Any suitable means could be used to movably mount the sliders to the frame including, for example, projections from the frame extending into slots in the sliders.

Referring also to FIG. 10A an alternate embodiment of the connector of FIG. 10 is shown. In this embodiment, the connector 200′ is the same as that shown in FIG. 10, but includes springs 201 (shown in an exploded view from the rest of the connector). Each spring 201 has a first end 203 and a second end 205. The first ends 203 are larger than the holes 207. The holes 207 extend into the slots 208 from the ends 209 of the frame 202. The rest of the springs 201 are suitably sized to fit inside the holes 207 and slots 208. The second ends 205 are adapted to mount on the pins 220 in the slots 208. Thus, the springs 201 pull the top sliders 216 of the slider sets 204, 206 towards their respective ends 209. In alternate embodiments any suitable spring(s) or mounting of the spring(s) to the frame and/or sliders could be provided.

Referring now to FIG. 13, another embodiment is shown. In this embodiment the connector 300 comprises a frame 302 and two sets 304, 306 of sliders. The frame 302 has a general “U” shaped cross-section with grooves 308, 310 and 312 on its legs. The top sliders 314 have lateral projections 316 which are slidably located in the top grooves 308, 310. The bottom sliders 318 have lateral projections 320 that are slidably located in the bottom grooves 312. The top grooves 308, 310 are angles relative to the bottom grooves 312. A washer 322 is located against each set 304, 306 of sliders. A spring 324 is located between the two washers. The spring biases the sets 304, 306 towards their clamping positions. This embodiment illustrated as an example that spring(s) could be used with features of the present invention.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. An electrical connector comprising:
a frame; and
a first set of clamping sliders comprising a first claming clamping slider movably connected to the frame, and a second clamping slider movably connected to the frame,
wherein the first and second sliders are located opposite each other with a first conductor receiving area therebetween, wherein the first and second sliders have slide paths along the frame which are angled relative to each other, and wherein the slide path of the second slider is substantially parallel to a center longitudinal axis of the conductor receiving area.

2. An electrical connector as in claim 1 wherein the frame comprises a one-piece metal member having a general cross-sectional “U” shaped section.

3. An electrical connector as in claim 1 wherein the frame comprises guide grooves and at least one of the sliders comprises projections slidably located in the guide grooves.

4. An electrical connector as in claim 1 wherein the frame and the sliders comprise guide grooves and projections located in the guide grooves to define the slide paths.

5. An electrical connector as in claim 4 wherein the grooves for the first slider are angled relative to the groove for the second slider.

6. An electrical connector as in claim 1 wherein the first slider comprises guide features on lateral sides of the frame having first longitudinal axes and a conductor contact surface having a second longitudinal axis angled relative to the first longitudinal axes.

7. An electrical connector as in claim 1 wherein the first slider has a general wedge shape with a front end having a smaller height than a rear end.

8. An electrical connector as in claim 1 further comprising a second set of clamping sliders comprising a third clamping slider movably connected to the frame, and a fourth clamping slider movably connected to the frame opposite the third slider with a second conductor receiving area therebetween.

9. An electrical connector as in claim 8 wherein the third and fourth sliders have slide paths along the frame which are angled relative to each other.

10. An electrical connector as in claim 9 wherein the slide path of the fourth slider is substantially parallel to a center longitudinal axis of the second conductor receiving area.

11. An electrical connector as in claim 8 wherein the first set of sliders and the second set of sliders can alternatively be located at a same section of the frame, wherein the sets of sliders have overlapping slide paths.

12. An electrical connector as in claim 1 wherein the frame comprises a body and inserts stationarily connected to the body, the inserts at least partially defining guide grooves for lateral projections on one of the sliders to slide along.

13. An electrical connector as in claim 12 wherein each insert comprises two of the grooves which are angled relative to each other.

14. An electrical connector as in claim 12 wherein the body comprises main grooves and the inserts partially block the main grooves to form the main grooves into the guide grooves.

15. An electrical connector as in claim 1 wherein the frame and the second slider comprise a guide groove and a projection in the guide groove along an interior central curved surface of the frame and a bottom surface of the second slider.

16. An electrical connector comprising:
a frame having a general cross-sectional “U” shape; and
two wedges movably mounted to the frame, each wedge having a conductor contacting surface facing a same direction towards a curved section of the general “U” shape of the frame and each wedge having a slide path along the frame towards a respective different end of the frame, wherein the respective slide paths towards the ends are angled to move the wedges towards the curved section as the wedges approach their respective ends.

17. An electrical connector as in claim 16 further comprising inserts stationarily connected to a body member of the frame, wherein the inserts at least partially define guide grooves for the wedges to move along.

18. An electrical connector as in claim 17 wherein each wedge comprises lateral projections extending into the guide grooves.

19. An electrical connector as in claim 16 wherein the frame and the wedges comprise guide grooves and projections slidably located in the guide grooves.

20. An electrical connector as in claim 16 further comprising two sliders movably mounted to the frame, each slider having a conductor contact surface facing a respective one of the wedges.

21. An electrical connector as in claim 21 wherein the sliders are attached to the curved section of the frame.

22. An electrical connector as in claim 21 wherein the sliders are movably mounted to the frame along parallel paths.

23. An electrical connector as in claim 16 wherein the slide paths of the wedges overlap each other.

24. An electrical connector comprising:
a frame having a general cross-sectional “U” shape and guide grooves on inward sides of legs of the general “U” shape; and
a wedge movably mounted to the frame, the wedge comprising two opposite sides having projections extending into the guide grooves and a conductor contact surface on a side which connects the two opposite sides, wherein the projections each have a longitudinal axis which is angled relative to a longitudinal axis of the conductor contact surface.

25. An electrical connector as in claim 24 further comprising inserts stationarily connected to a body member of the frame, wherein the inserts at least partially define the guide grooves for the projections to move along.

26. An electrical connector as in claim 24 further comprising a slider movably mounted to the frame, the slider having a conductor contact surface facing the conductor contact surface of the wedge.

27. An electrical connector as in claim 26 wherein the slider is slidably mounted on a curved section of the frame.

28. A method of manufacturing an electrical conductor comprising steps of:
extruding a connector body having an elongate shape with an elongate conductor receiving area inside the body along the elongate shape;
slidably mounting a wedge in the receiving area to opposite sides of the frame such that the wedge can slide along the elongate conductor receiving area, wherein the wedge and body comprise a mating slidable groove and projection which guides a slide path of the wedge along the body.
